(19) United States
(12) Patent Application Publication
(10) Pub. No.: US 2012/0148978 A1
(43) Pub. Date: Jun. 14, 2012

(54) Impression Tray

(75) Inventors: Matthias Suchan, Hachenburg (DE); Alexander Bublewitz, Herborn (DE); Jens-Peter Reber, Meinerzhagen (DE)

(73) Assignee: KETTENBACH GMBH & CO. KG, Eschenburg (DE)

(21) Appl. No.: 13/281,327

(22) Filed: Oct. 25, 2011

(30) Foreign Application Priority Data
Oct. 26, 2010 (DE) 102010049377.5

(51) Int. Cl. A61C 9/00

(52) U.S. Cl. 433/38

(57) ABSTRACT

A dental impression tray having a tray bottom, an inner wall and an outer wall, which together form the dental mold, whereby the inner and/or outer wall, on their side facing away from the tray bottom is provided at least in sections with a resilient, in particular, elastic element consisting of a softer material compared to that of the wall on which it is located, wherein the element is designed as resilient lip that is located opposite of the wall on which lip is located, aligned inclined toward the interior of the dental mold.

The invention relates to a dental impression tray having a tray bottom, an inner wall and an outer wall, which together form a dental mold. The inner and/or outer wall have a softer material on their side facing away from the tray bottom, i.e. at the free edge facing away from the tray bottom of the respective inner or outer wall, at least in sections, with a resilient, in particular flexible or elastic element compared with the wall on which it is located.

Impression trays are known, for example, from DE 10 2008 029 765 A1. These types of impression trays are used for taking impressions of an upper jaw and/or lower jaw by using an impression material. A further possibility of application for impression trays of this type is the production of a dental splint or other dental products. These types of impression trays most often consist of metal or a hard plastic at ambient temperatures, in order to be able to press the impression material against the teeth of which an impression is to be made using pressure, while taking the impression. When the tray is inserted deeply, a patient can experience pressure points, for example, at the fold-over, which are perceived to be painful. Further, in some cases of application it has been found to be disadvantageous when, dependent on the geometry of the tooth situation that is to molded, the impression material can flow too easily past the teeth, over the edge of the tray, i.e. it flows largely perpendicularly past the point of the largest dental circumference, without flowing into the undercut positions. As a result, in particular in the case of positions underneath, i.e. undercut positions, it is possible that the impression will not be sufficiently true to detail.

To increase the precision of an impression, in EP 0 884 981 B1, an impression tray of the type cited above is proposed, in which the interior of the tray is connected with an impression material connection element and a vacuum connection element. In this way, the impression tray can be filled particularly completely with impression material in the mouth of the patient, without creating cavities filled with air. The free edges of the tray was are provided with a gasket system for this purpose, which can form a sealing position together with the soft tissue of the mouth of a patient. This known gasket system has several layers with a sealing strip and, for example, a cylindrical sealing element that is located on it. Because of the complicated geometry and the multi-part composition of this known impression tray, it is also, considering the required devices for feeding the impression material and the vacuum suction, much too laborious and expensive for standard cases of taking an impression or for producing dental splints. In addition, due to the low height of the known gasket system it cannot always be reliably ensured that the impression material cannot flow away over the edge of the tray.

It is therefore the objective of the present invention to provide a simple and cost-effective impression tray of the type cited above, which makes an impression possible, particularly down to the last detail, in the presence of improved patient comfort.

According to the invention, this problem is substantially solved with an impression tray having the characteristics recited in Claim 1. Thereby, the invention is based on the idea of providing an element formed as a resilient or flexible lip on the side facing away from the tray bottom, i.e. on the free edge, of at least one wall, as well as, if necessary, also in the retro molar area OF the dorsal limitation of the upper jaw tray to the hard/soft palate.

With the impression tray according to the invention, the impression material can be guided even closer to the row of teeth when the lip is located opposite the inner or outer wall on which the lip is respectively located, inclined in the direction to the inner lining of the dental mold. In other words, the flexible lip is, according to the invention, also independent of the previously described features, preferably inclined at least approximately 5°, and particularly preferred approximately 10° to approximately 50° in the direction of the other wall. It is thereby preferred when the lip is inclined toward the interior in the direction to the dental mold and in addition, is attached in such a way that it projects over the inner tray edge at the inner and/or outer wall. As a result of the gradient of the lip, flow noses can also be avoided, which could be created when the impression material is not flowing into positions underneath, but flows perpendicular off the tooth. This design of the impression tray according to the invention also particularly effectively avoids that the impression material can simply flow off over the edge of the tray, without being guided to the jaw or to the surface of the tooth. Because of the lip contour that is inclined into the interior, the direction of flow of the displaced impression material is guided in the direction of the tooth surface or jaw surface and thus makes an impression possible that is particularly precise, down to the last detail.

According to the invention, the flexible lip can, independent of the previously cited features, be an integral component of the impression tray when it is supplied by the manufacturer as a part. Alternatively, it is possible that the flexible lip can be fastened subsequently to the impression tray using mechanical fastening tools and/or essentially be detached from it nondestructively. Thereby, the flexible lip can be exchanged, while the tray itself can be reusable.

According to a further aspect of the present invention, the height of the lip is to be larger than its thickness in a direction that is approximately perpendicular to the direction that is essentially parallel to an inner or outer wall. Due to this design of an impression tray with a flexible or resilient lip, the impression material is guided better to the row of teeth and a flowing away of the impression material over the edge of the tray is significantly impeded. This improves the impression of a tooth situation down to the last detail. Simultaneously, the lip that is softer and more resilient compared to the other tray material can avoid painful pressure points, for example, in the fold-over of the patient when the tray is inserted deeply, and thus enhance the patient's comfort and reduce the risk of injury.

The progression of the dental mold formed by the impression tray is roughly adapted to the progression of the jaw, or the progression of a part of the jaw. Thus, the tray bottom for the lower jaw can be approximately horseshoe-shaped when viewed from the top, whereby the inner and outer wall extends at least close to rectangular to this, away from the tray bottom. For the upper jaw, the tray is designed with a palate roof. The dental mold thus has a cross section that is approximately U-shaped. If the upper and lower jaw is to be molded simultaneously, the inner and the outer wall extend in both directions of the tray bottom which can then, for example, also be formed by a fibrous web. To mold one half of the arc of the jaw, the walls as well as the tray bottom can be shortened correspondingly in contrast to a tray for molding an entire jaw.

In the following, the height of the resilient lip is defined as its extension in elongation of the walls, this means, approximately perpendicular to the plane of the tray bottom. In other words, the height of the lip is the distance by which the lip protrudes over the free edge of the respective hard wall. The thickness of the lip that is preferably lower by at least a factor of 1.5, in particular at least by a factor of 2, and particularly preferred approximately by a factor of 3 than its height, is to be measured in a perpendicular direction hereto, i.e. approximately parallel to the plane of the tray bottom. In contrast, the lip length is described as the length at which the lip extends along the free edge of the respective wall. When the lip extends over the entire length of the wall, the lip is therewith designed for an impression tray for an entire jaw, approximately U-shaped as an arc.

Independent of the previously described features, the structure of the impression tray according to the invention can thereby be kept particularly simple, if the resilient lip is fastened directly with that wall, on which the lip is located, whereby the lip defines, at least in sections, the free edge of the tray that is facing away from the tray bottom. In other words, the resilient lip is provided as an extension of the respective wall in a direction away from the bottom of the tray. Advantageously, no additional elements are provided between the lip and the wall.

In a further development of this inventive idea it is provided that the resilient lip extends cambered in the direction of its height. Thereby, the free edge of the lip that is facing away from the tray bottom is facing the interior of the dental mold. This curve can further advantageously influence the direction of flow of the displaced impression material.

The resilient lip can, for example, be attached with mechanical retentions and/or by using conglutination at the free edge of the respective wall. The lip can thereby either be designed complete around both was of the tray and dorsal to the section of the last molar, or the dorsal limitation of the upper jaw tray to the hard/soft palate in the section of the tray bottom can be revolving, or cover only sections of the wall. Thereby, it is particularly preferred when the lip is formed continuous on the free edges of the was on their entire length, while dorsal to the last molar, an interruption of the lip is provided. The production of the impression tray according to the invention having the resilient lip—according to a particularly preferred embodiment—is executed using a two-component extrusion process, whereby the lip is directly connected with the impression tray during its production.

The hardness of the resilient lip is preferably significantly less than that of the other molding trays. It has been shown to be particularly advantageous when the material of the resilient lip has a hardness of approximately 10 to approximately 95 shore (as measured according to DIN 53505 or DIN 7868 shore-A), in particular between approximately 20 shore and approximately 80 shore, preferably 30 to 70 shore. The lip or the flexible element can consist of an elastic and/or plastically deformable material.

The resilient lip consists of an elastic material that is suitable for taking the impression in the mouth. This can, for example, be silicone, a thermoplastic elastomer (TPE), polyurethane (PU) or natural rubber. Alternatively, it is also possible to provide the lip consisting of a plastically deformable material at the edge or at the free edge of the walls of the impression tray. This plastic lip can, for example, stand up while the impression is being taken and additionally form a fold-over. This type of embodiment with a plastic lip is, for example, suitable for impression trays for use in toothless or partially toothed jaws.

The resilient lip is preferably designed in a color that is different from the material of the remaining impression tray and/or has a different opacity. As a result, the transition between the comparably stiff impression tray and the lip that is located on it is easily recognizable visually. This can, for example, be used as the fill level of the impression tray by using this separation line between the tray body and the softer lip. Further, the color identification of the lip can also be used to differentiate different tray types and tray sizes.

According to one embodiment of the invention, the material of the lip can connect with the impression material either by means of an adhesive layer and/or through mechanical retentions or perforations. According to a further preferred embodiment, such a connection between the impression material and the lip material is intentionally avoided in order to avoid a deformation of the hardened impression after removal, due to elastic reset forces. For this, the resilient lip or its material are designed and/or equipped in such a way that the impression material is essentially removable from the lip without residue.

In order to also, in particular in the case of long front teeth, make the production of a dental splint or the like, or the complete impression of a largely toothed jaw possible, a first section of the tray bottom can extend in a first plane that is essentially perpendicular to the inner well and/or to the outer wall, while at least one additional section of the tray bottom extends in an additional plane that is offset to the first plane. In this way, a section having larger depth and at least one additional section with less depth are created in the tray bottom. This makes a precise impression of the tooth area possible, even in the case of long front teeth. These sections that lie in various planes of the tray bottom do not need to be formed completely flat, but can, for example, have a small curve or arching. The transition between the two planes can be designed in the form of a step or an intermediate plane that is inclined ramp-like.

The impression tray according to the invention can, at least in one section of the tray bottom, be provided with through-holes. These through-holes make it possible for the impression material to pass through the tray bottom and harden there, so that a mechanical connection is established between the impression material and the tray bottom, which avoids a detachment of the impression material when the tray is removed from the mouth of the patient. If in addition to the impression material, an indicator material that is, in particular, different in color from the impression material, is filled into the impression tray, it can, together with the impression material, be used as an indicator that the tray has been inserted into the mouth of the patient correctly or completely.

Additionally, or alternatively to this, an adhesive or other mechanical retentions can improve the connection between the impression material and the impression tray. If protruding bars or ribs are formed on the side of the walls facing the interior of the dental mold which, for example, extend in a direction pointing away from the tray bottom, this can avoid detachment of the impression material from the tray. If necessary, this can be further improved by perforations or through-holes, for example, in the tray bottom and/or the walls. Hereby, it is preferred when in the tray bottom in the area of the front teeth, first through-holes and in the dorsal (posterior) section, second through-holes are formed, of which the first through-holes have a smaller diameter than the second through-holes. This makes it possible even at the lower impact pressure of the impression material in the dorsal section of the tray to obtain a sufficient connection between the impression material and the tray. Alternatively, it is possible that in the tray bottom of the impression tray, first through-holes are formed in the area of the front teeth, and in the direction of the dorsal section, through-holes are formed that become progressively larger.

In the following, the invention will be described in more detail with the help of exemplary embodiments and by referring to the drawing. Thereby, all described and/or figuratively illustrated characteristics by themselves or in any sensible combination constitute the subject matter of the invention, independent of their abstract in the claims or their references.

Schematically shown are:

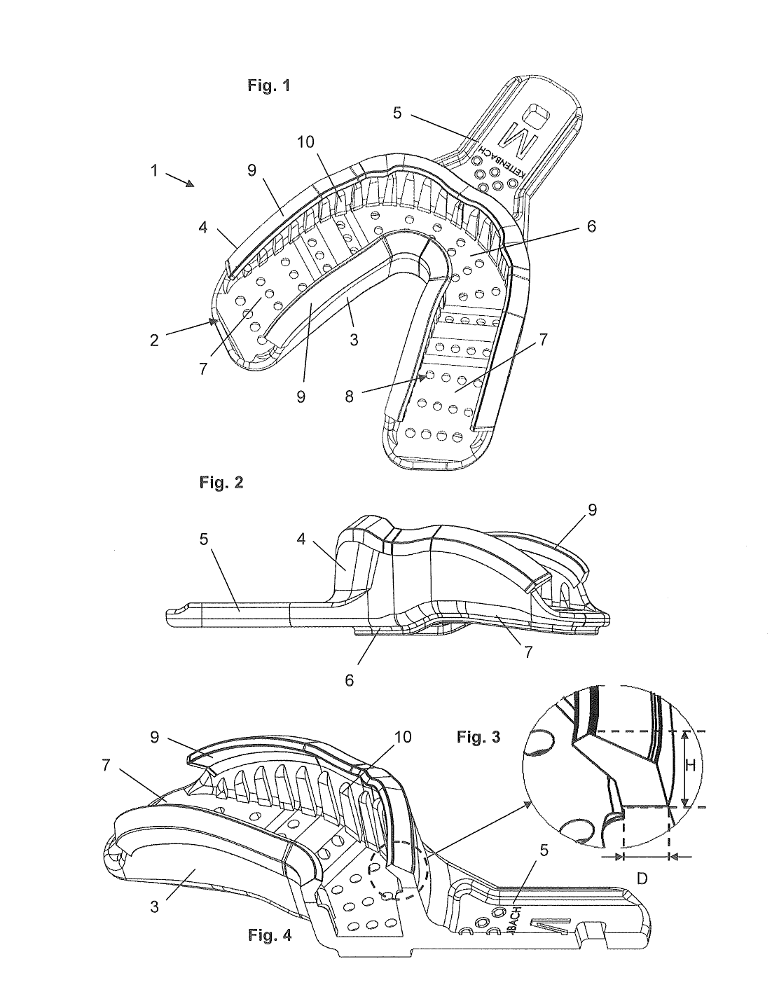

FIG. 1 a top view of an impression tray according to a first embodiment of the invention;

FIG. 2 the impression tray in a lateral view according to FIG. 1;

FIG. 3 the impression tray in a partially cross-sectional lateral view according to FIG. 1;

FIG. 4 a top view of an impression tray according to a second embodiment of the invention;

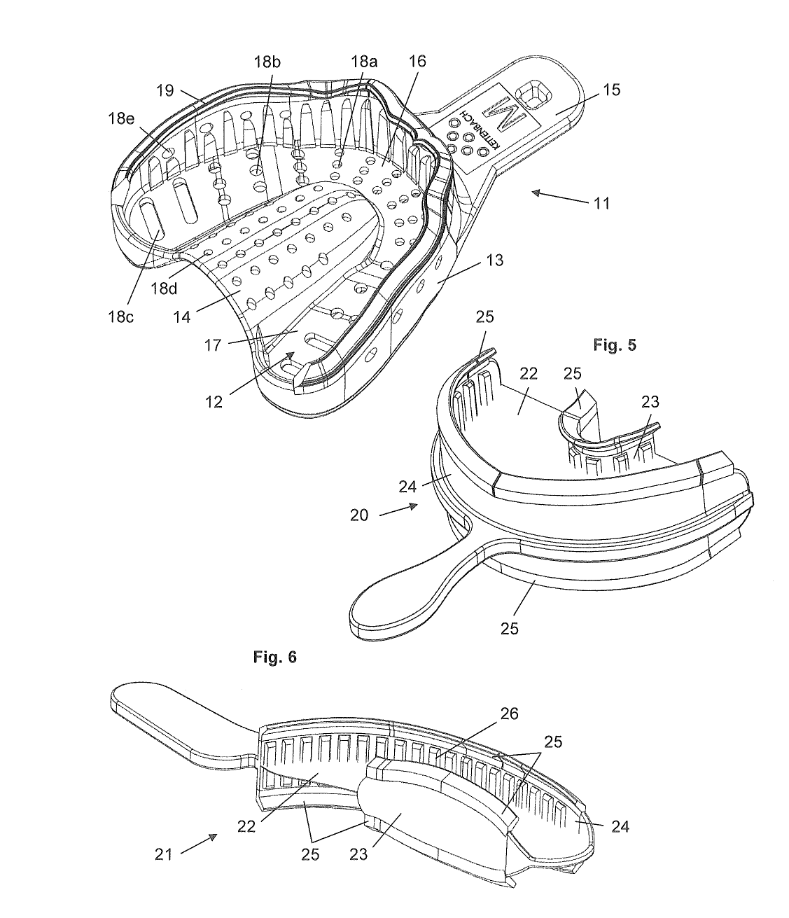

FIG. 5 a top view of an impression tray according to a third embodiment of the invention;

FIG. 6 a top view of an impression tray according to a fourth embodiment of the invention;

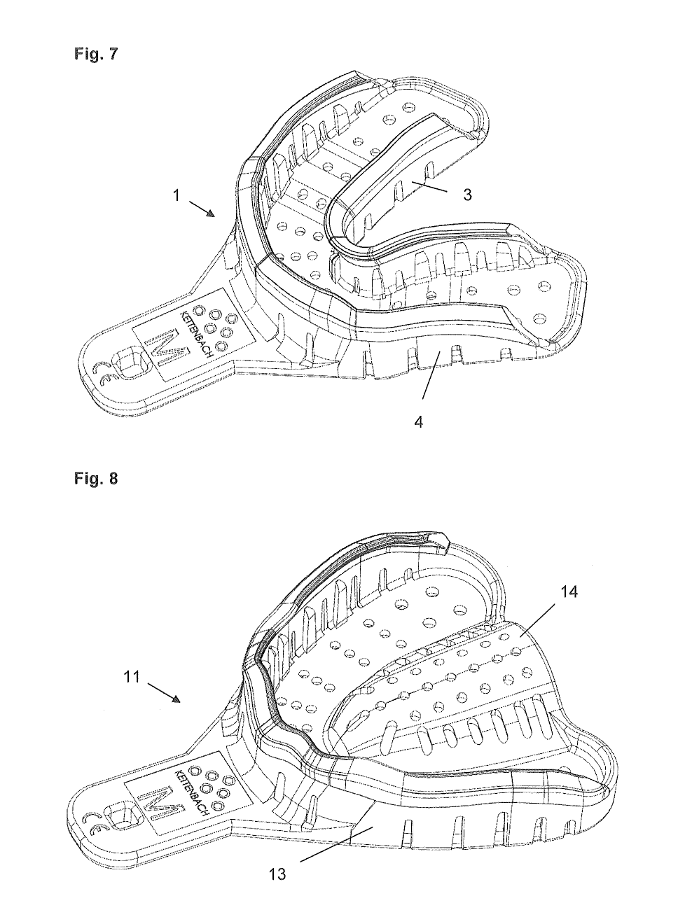

FIG. 7 a top view of an impression tray according to a fifth embodiment of the invention; and

FIG. 8 a top view of an impression tray according to a sixth embodiment of the invention.

Impression tray 1 illustrated in FIGS. 1 through 3 is formed by a tray bottom 2 and by an inner wall 3 and by an outer wall 4, which project away from tray bottom 2. Tray bottom 2 thus forms, together with inner wall 3 and outer wall 4, a dental mold for receiving—not shown in the figures—impression material or die material. Moreover, a handle 5 is provided in the illustrated embodiment, which is formed integral with impression tray 1. Because of the design of impression tray 1 that is adapted to the shape of the jaw, perhaps a design bent into a horseshoe-shape, it is particularly suitable for taking an impression of a fully toothed lower jaw.

In the illustrated embodiment, tray bottom 2 is formed by a first, approximately U-shaped section 6 (area of the front teeth) and two—respectively connected with it by a transition section—bracket sections 7 (lateral tooth areas). Thereby, U-shaped section 6 and the two bracket sections 7 lie in a plane offset to each other. The depth of tray 1 is thus larger in the section of the U-shaped section 6 than that in the sections of the two bracket sections 7 facing away from handle 5. Further, several through-holes 8 are provided in tray bottom 2.

Inner wall 3 and outer wall 4 extend almost perpendicular away from tray bottom 2 in the illustrated embodiment. The free edge of walls 3, 4 that is facing away from tray bottom 2 is provided with a flexible lip 9, which extends curved over the entire length of the upper edge of walls 3 or 4. As can be seen in particular in the illustration of FIG. 3, lip 9 is bent or inclined inward by approximately 10° to approximately 50°, i.e. the upper free edge of lip 9 respectively points in the direction of the interior of the dental mold of impression tray 1. As can further be seen in FIG. 3, the thickness D of lip 9 is less than its height H.

In the embodiment according to FIGS. 1 to 3, in the interior of the dental mold, i.e. on the sides of inner wall 3 and outer wall 4 that are facing each other, several ribs 10 with positions posterior to them are provided that essentially extend away from impression tray 2. Ribs 10 can prevent a detachment of impression material from the tray. In addition, ribs 10, together with holes 8 serve to improve a mechanical connection (retention) of the impression material with tray 1.

FIG. 4 shows an impression tray 11 that is suitable for taking an impression of an upper jaw. In contrast to tray 1 shown in FIGS. 1 through 3 for a lower jaw, impression tray 11 has, in addition to a tray bottom 12 and an outer wall 13, a palate roof 14, which forms at least at a rudimentary level, an inner wall. Tray bottom 12 thus forms a dental mold together with the outer wall 13 for receiving an impression material or die material that is not shown in the figures. Moreover, in the illustrated embodiment, a handle 15 is provided, which is designed integral with impression tray 11.

Tray bottom 12, similar to the embodiment shown in FIGS. 1 through 3, is formed with a first, approximately U-shaped section 16 and two bracket sections 17, respectively connected with it by a transition section in a plane offset to section 16.

Further, in tray bottom 12, several through-holes are provided of which those through-holes 18a located in U-shaped section 16 have a smaller aperture cross section, through-holes 18b located in the transition section have a medium aperture cross section, and those located in bracket sections 17, elongated through-holes 18c, have a larger aperture. The aperture cross sections can also become successively larger from the front tooth area to the dorsal area. The form and size of the openings can thereby vary depending on position. Even in palate roof 14, through-holes 18d are provided, the size of which corresponds approximately to those in U-shaped section 16. Additionally, even in outer wall 13, in addition to the ribs located on the inner side, through-holes 18e are provided. These through-holes 18a through 18e permit that a small part of the impression material or die material passes through tray bottom 12, wall 13 or palate roof 14, and after hardening establishes, together with the undercut ribs in wall 13, a mechanical connection with tray 11.

Even in tray 11, on the free edge of outer wall 13 facing away from tray bottom 12, a flexible lip 19 that is curved inward is provided, which extends curved over the entire length of the upper edge of outer wall 13 and marginally up to the retro molar (posterior) section. On palate roof 14, no such lip is formed.

According to additional embodiments shown in FIGS. 5 and 6, tray 20 or 21 can be designed as a so-called dual-arch-tray impression tray. In such dual-arch-trays (for example triple-tray trays from Premier Dental), the tray bottom is formed by a thin fibrous web or fabric layer 22. Thus, the tray bottom is located approximately in the center of the impression tray, whereby inner walls 23, as well as outer walls 24 extend away from the tray bottom in both directions. Dual-arch-tray impression trays are thus suitable for taking simultaneous impressions of both jaws. Thereby, the dual-arch-tray impression trays can either be approximately horseshoe-shaped for taking an impression of the entire jaw (FIG. 5) or be shortened correspondingly for taking an impression of one half of the jaw (FIG. 6).

Even dual-arch-tray impression trays 20 and 21 are provided, respectively on the free edges of walls 23 or 24 facing away from tray bottom 22, with a flexible lip 25 that is bent inward, as well as with ribs 26 formed on the inside of walls 23 or 24. Inner walls 23 can either be fastened either only via the fibrous web or fabric layer 22 of the tray bottom with outer walls 24 (FIG. 5), or by, for example, a curved connection piece (FIG. 6) with outer walls 24.

In principle, the impression trays can be produced from plastic and/or metal. It has been shown to be particularly advantageous when lip 9, 19 or 25 is integrally connected with the remaining tray in a two-component extrusion process, which is then connected, at least in part, by a plastic that is solid at body temperature.

in FIGS. 7 and 8, additional embodiments are shown that essentially correspond to the embodiments according to FIG. 1 or 4 and illustrate an impression tray for a lower jaw (FIG. 7) or an upper jaw (FIG. 8). In contrast to the embodiments according to FIG. 1 or 4, the openings provided in outer walls 4 or 13 are designed groove-shaped to improve retention. In addition, in the impression tray for a lower jaw (FIG. 7), slots are also provided in inner wall 3 or elongated holes are provided in the palate roof of the impression tray for an upper jaw (FIG. 8).

### REFERENCE NUMBERS

1 Impression tray
2 Tray bottom
3 Inner wall
4 Outer wall
5 Handle
6 U-shaped section (front tooth area)
7 Bracket section (lateral tooth area)
8 Through-hole
9 Up
10 Rib
11 Impression tray
12 Tray bottom
13 Outer wall
14 Palate roof
15 Handle
16 U-shaped section (front tooth area)
17 Bracket section (lateral tooth area)
18a-e Through-hole aperture/opening
19 Lip
20 Impression tray
21 Impression tray
22 Tray bottom
23 Inner wall
24 Outer wall
25 Lip
26 Rib

1. A dental impression tray having a tray bottom, an inner wall and an outer wall, which together form the dental mold, whereby the inner and/or outer wall, on their side facing away from the tray bottom is provided at least in sections with a resilient, in particular, elastic element consisting of a softer material compared to that of the wall on which it is located, wherein the element is designed as resilient lip that is located opposite of the wall on which lip is located, aligned inclined toward the interior of the dental mold.

2. An impression tray as recited in claim 1, wherein the resilient lip is located opposite of the wall on which the lip is located, aligned inclined by at least 5° in the direction toward the interior of the dental mold and/or is attached in such a way that it projects over the free edge of the inner and/or outer wall on the inner side of the dental mold.

3. An impression tray as recited in claim 1, wherein the height (H) of the resilient lip in an essentially parallel direction to an inner and/or outer wall, is larger than its thickness (D) in a direction that is approximately perpendicular hereto.

4. An impression tray as recited in claim 3, wherein the height (H) of resilient lip is larger by at least a factor of 1.5, in particular at least by a factor of 2 than its thickness (D).

5. An impression tray, in particular as recited in claim 1, wherein the resilient lip is located directly fastened on the wall on which the lip is located, and that this lip defines, at least in sections, the free edge of the impression tray that is facing away from the tray bottom.

6. An impression tray as recited in claim 1, wherein the resilient lip extends curved in the direction of its height, whereby the free edge of the lip facing away from tray bottom faces the interior of the dental mold.

7. An impression tray as recited in claim 1, wherein the lip is an integral part of the impression tray as it is supplied by the manufacturer, in particular, that the resilient lip, is, for example, by being produced in a two-component extrusion process, located integrally designed with the wall, on which the lip is located.

8. An impression tray as recited in claim 1, wherein the material of the resilient lip has a hardness of less than approximately 10 to approximately 95 shore.

9. An impression tray as recited in claim 1, wherein the resilient lip has a different color and/or a different opacity than the wall on which the lip is located.

10. An impression tray as recited in claim 1, wherein the resilient lip and/or its material is designed in such a way and/or equipped in such a way that the impression material can be detached from the lip essentially residue-free.

11. An impression tray as recited in claim 1, wherein the resilient lip consists of a suitable elastic material for taking an impression in the mouth, in particular silicone, TPE, PU or natural rubber.

12. An impression tray as recited in claim 1, wherein the first through-holes are formed in the tray bottom in the front tooth area and in the dorsal section, second through-holes are formed, whereby the first through-holes have a smaller diameter than the second through-holes.
